(19) United States
(12) Patent Application Publication
(10) Pub. No.: US 2007/0041209 A1
(43) Pub. Date: Feb. 22, 2007

(54) Visual marker for hunters and outdoorsmen

(76) Inventor: Ralph Glass, Versailles, KY (US)

Correspondence Address: JAMES M. FRANCIS, 300 W VINE ST, STOLL KEENON OGDEN PLLC, LEXINGTON, KY, 40507, US

(21) Appl. No.: 11/441,902

(22) Filed: May 26, 2006

Related U.S. Application Data
(60) Provisional application No. 60/684,901, filed on May 26, 2005.

(51) Int. Cl. F21S 8/10

(52) U.S. Cl. 362/545

(57) ABSTRACT

The present invention is a lighted visual marker or beacon for use primarily by outdoorsmen. The device utilizes LED bulbs that emit a green light that is inoffensive to nocturnal wildlife so as not to alarm them. The device may be mounted to or suspended from a tree or mounted in the ground to provide guidance to paths, campsites, tree-stands and the like. The device is battery powered and capable of being controlled from a control panel beneath a weatherproof cover or can be remotely controlled. The device may be controlled in a simple on/off mode of operation or can be controlled by a timer.

### CROSS REFERENCE TO RELATED APPLICATIONS

This application claims priority from U.S. Provisional Application No. 60/684,901 filed on May 26, 2005. This application relates to a Visual Marker for Hunters and Outdoorsmen. The entire disclosure contained in U.S. Provisional Application No. 60/684,901 including the attachments thereto, are incorporated herein by reference.

### BACKGROUND OF THE INVENTION

1. Field of the Invention

This device relates generally to visual marker to assist in navigation in near to total dark situations. More particularly, this device relates to a visual marker utilizing LED bulbs to assist hunters and outdoorsmen in locating the marked location without disturbing wildlife.

2. Problems in the Art

Hunters and outdoorsmen have long been plagued by the problem of finding their way in the dark. Hunters especially face this problem in locating tree stands or hidden equipment. This problem creates safety concerns since many hunters and outdoorsmen have lost their way at night due to the near total darkness in the wilderness. This problem has resulted in hunters becoming lost resulting in injury and sometimes death.

The prior art contains numerous references to inventions to assist people to locate marked locations or guide them along paths. However, none of the reviewed prior art provide a visual marker that can be seen from multiple angles, produces a light that is invisible to nocturnal wildlife yet visible to humans, contains a timer, and can be remotely controlled.

U.S. Patents Application 20020152948 (published Oct. 24, 2002) and U.S. Pat. No. 6,264,335 (Jul. 24, 2001) describe the use of reflective markers to aid in night navigation in the wilderness. However, both require that the hunter use an external light source that must be reflected. This approach contains several problems for hunters in that the light must be directed to a reflector whose location may not be readily apparent. Also, the movement of the light while searching for reflective markers could startle the hunter's prey. The present invention offers both a light source that is stationary and will be noticed by the hunter without by a visual search and offers a light source that will not alarm wildlife.

U.S. Pat. Nos. 7,046,160 (May 16, 2006); 6,995,681 (Feb. 7, 2006); 6,992,591 (Jan. 31, 2006); 6,511,203 (Jan. 28, 2003); and 6,137,396 (Oct. 24, 2000) are illustrative of the use of LED's as portable warning lights or markers or beacons. However, each fail to mention potential uses for hunters and more specifically fail to describe the method of restricting the wavelength of light emitted to that which cannot be detected by the hunter's prey of choice.

### SUMMARY OF THE INVENTION

The present invention utilizes LED bulbs which consume little energy and produce light which will not alarm nocturnal wildlife. Preferably, the LED emit light of The device is provided with a sturdy casing which possesses at least one LED bulb. The LED bulb or bulbs are situated such that the light can be easily seen from all sides of the device. The device also incorporates a timer mechanism so that the device can be activated at a present time. The timer is preferably silent. The device can also be constructed to be activated remotely upon command.

The device is of sturdy construction and is also weather proof. The operating keypad can be hidden from view and protected from the elements by a simple hinged or sliding cover.

The light from the LED bulb is capable of detection by the human eye from a considerable distance in near total darkness. Additionally, the wavelength of light emitted by a green LED bulb is of such that the human eye has minimal readjustment to darkness after being exposed to this wavelength of light.

Accordingly, those skilled in the art will appreciated that the concept upon which this invention is based may readily be utilized as a basis for the design of other structures, methods, and systems for carrying out the several purposes of the present invention. It is important, therefore, that the claims and specification be regarded as including such equivalent constructions insofar as they do not depart from the spirit of the present invention.

### BRIEF DESCRIPTION OF THE DRAWINGS

Additional utility and features of the invention will become more fully apparent to those skilled in the art by reference to the following drawings, which illustrate the primary features of the preferred embodiment and numerous alternative embodiments.

FIG. 1 is a perspective view of the present invention viewed from the front of the device.

FIG. 2 is an exploded perspective view of the present invention.

FIG. 3 is a perspective view of base of the present invention with the cover in place.

FIG. 4 is a perspective view of the front of the present invention with the cover removed.

### DETAILED DESCRIPTION OF THE INVENTION

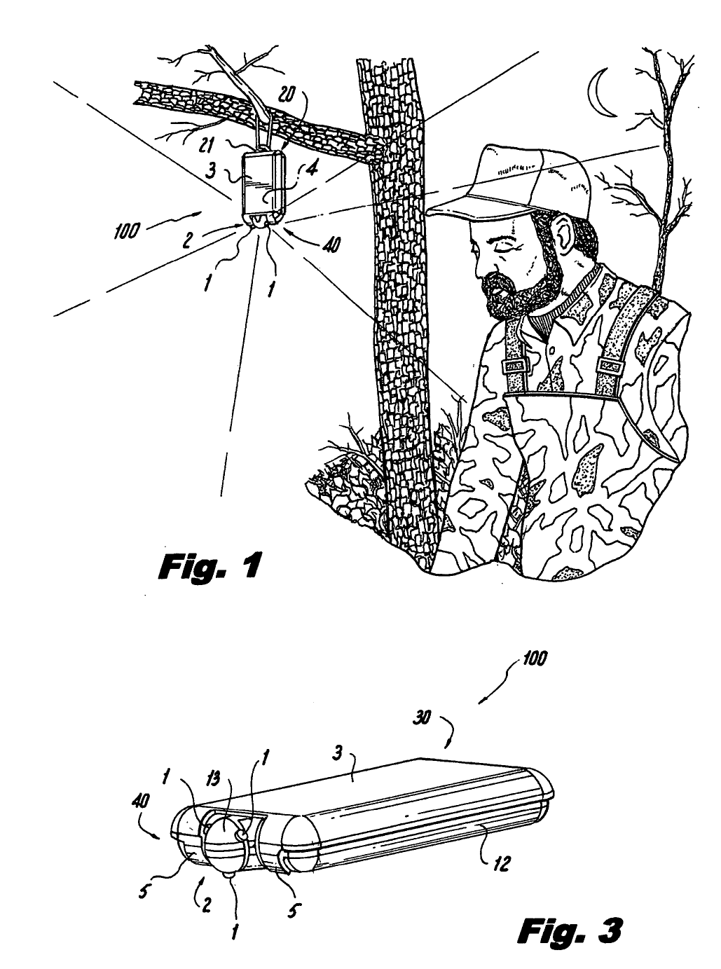

FIG. 1 depicts several of the principal components of the present invention. The LED bulbs 1 of the beacon device 100 are mounted at the base 40 of the device. Preferably the LED bulbs 1 are affixed to an LED bulb assembly 2 that juts from the base 40 of the device 100. The LED bulbs 1 are preferably spaced approximately 60° around a circular plane of the LED bulb assembly 2. A loop 21 is affixed to the top 20 of the beacon 100 to allow suspension from a nail, screw, branch, rope, or other mounting means. The beacon device 100 is intended to be placed into operable use with the base 10 positioned below the top 20 of the beacon 100 such that the view of the LED assembly 2 is not obstructed when viewing the suspended beacon 100. The face cover 3 is clearly shown to hide and protect the face 4 of the beacon 100.

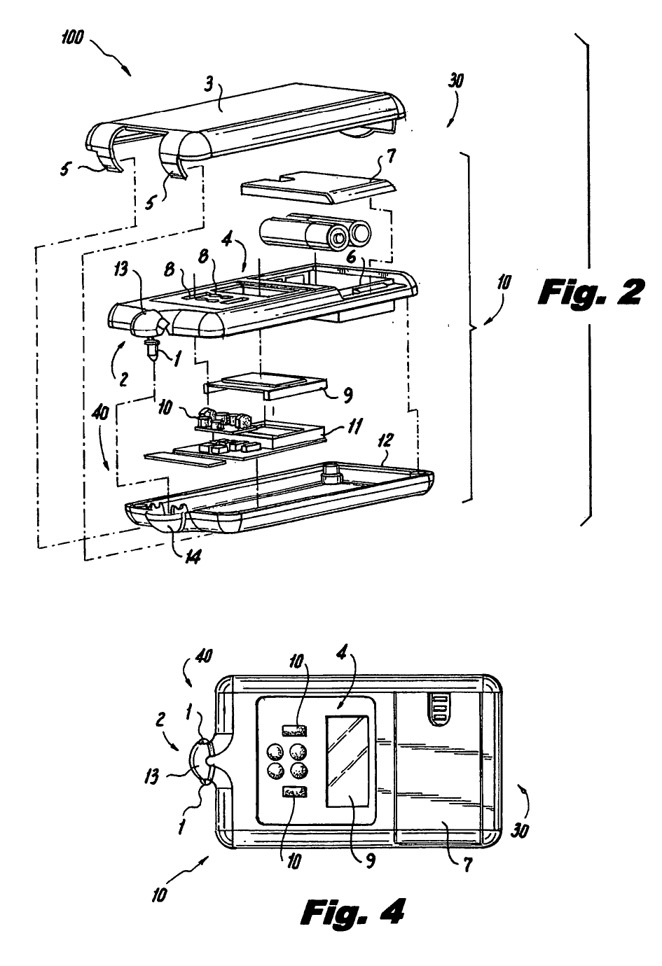

FIG. 2 depicts an exploded view of the beacon 100 with the principal components displayed. The cover 3 is shown to have cover tabs 5 which are curved toward the rear 30 of the beacon 100 secure the face cover 3 to the base 10 of the beacon 100 by sliding the curved cover tabs 5 over the curved bottom of the base 40. Beneath the face cover 3, the battery compartment 6 is depicted covered by a battery compartment cover 7 which attaches to the face 4 of the beacon 100. The face is further shown to possess component cut-outs 8 for the display cover 9, the button covers 10, and the integrated display/control mechanism 11 that preferably includes a microprocessor, a timer, a receiver, buttons, and associated circuitry that need not be depicted individually since they are well known to those skilled in the art.

The face 4 is further depicted to provide the LED bulb face housing 13 of the LED bulb assembly 2. Two of the LED bulbs 1 are depicted as being protruding through LED bulb face housing 13 of the LED bulb assembly 2. The rear cover 12 is shown to provide the LED bulb rear housing 14 of the LED bulb assembly 2. Another LED bulb 1 is depicted in position to protrude through the LED bulb rear housing 14 of the LED bulb assembly 2 when assembled.

The spaced arrangement of the LED bulbs 1 provides viewing from numerous angles relative to the beacon 100. The LED bulbs 1 are bright enough to be seen at a considerable distance yet not alarming to wildlife due to the wavelength of light emitted. LED bulbs 1 are extremely conservative with power therefore the beacon 100 could remain in place for many days.

Preferably the beacon 100 can be controlled remotely as well as directly by the user. A remote control or proximity signal could easily be incorporated into the beacon controls and circuitry and such technology is well known to those skilled in the art. The beacon 100 could also be used on a timed basis using simple timer mechanisms and/or circuitry.

An additional embodiment would allow the beacon's 100 integrated display/control mechanism and circuitry 11 to control satellite beacons. This control could either be wireless or wired as such technology is well known to those skilled in the art and widely available on a commercial basis.

Preferably the face cover 3, rear cover 12 and face 4 are constructed of sturdy materials suitable for outdoor use such as plastic, metal, metal alloys, fiberglass, and ceramics to name a few such materials. The face cover 3 provides a weatherproof seal from rain and other elements when attached to the face 4. Ideally the face cover 3 will be hingedly attached to the face 4 or rear cover 12.

What is claimed is:

1. A visual marker comprising:
(a) a housing;
(b) at least one LED bulb protruding from said housing, said LED bulb emitting a wavelength of light that will not disturb nocturnal animals; and
(c) a power source.

2. The visual marker of claim 1, wherein said wavelength of emitted light is visually perceived as the color green by the human eye.

3. The visual marker of claim 1, further comprising means to control said LED bulb.

4. The visual marker of claim 3, further comprising a means for timed operation of said LED bulb.

5. The visual marker of claim 3, further comprising a means to display the settings of said means to control said LED bulb.

6. The visual marker of claim 4, further comprising means to control additional visual markers from one said means to control said LED bulb.

7. The visual marker of claim 1, wherein said housing is sealed so as to make it waterproof.

8. The visual marker of claim 7, where said housing is constructed of materials from the group consisting of metals, metal alloys, fiberglass, plastics, or ceramics.

9. The visual marker of claim 8, wherein said housing possesses a means to suspend said housing.

10. The visual marker of claim 8, wherein said housing possesses means to mount said visual marker into the ground.

11. The visual marker of claim 1, wherein said at least one LED bulb is sited on said housing so that it may be seen posteriorally or anteriorally to the device.

12. The visual marker of claim 1, wherein said device possesses a means for remote operation.

13. A visual marker comprising:
(a) a housing;
(b) at least one LED bulb protruding from said housing, said LED bulb emitting a wavelength of light that will not disturb nocturnal animals;
(c) a portable power source;
(d) means to mount said housing;
(e) means to control said LED bulb;
(f) and means to waterproof said housing.

14. The visual marker of claim 13, wherein said wavelength of light is visually perceived as green by the human eye.

15. The visual marker of claim 13, wherein said housing is comprised of material selected from the group consisting of fiberglass, metals, metal alloys, plastics, ceramics and similar materials.

16. The visual marker of claim 14, wherein said means to control said LED bulb possesses means for timed operation and remote operation.

17. The method of using LED bulbs that emit light at wavelengths that are inoffensive to nocturnal animals as visual beacons.
